(19) United States
(12) Patent Application Publication
(10) Pub. No.: US 2013/0005180 A1
(43) Pub. Date: Jan. 3, 2013

(54) COAXIAL CABLE CONNECTOR HAVING A PLATED POST

(75) Inventors: Allen Lee Malloy, Elmira Heights, NY (US); Gary A. Knaus, Horseheads, NY (US)

(73) Assignee: Belden Inc.

(21) Appl. No.: 13/174,022

(22) Filed: Jun. 30, 2011

(51) Int. Cl. H01R 9/05; F16L 23/00; H01R 43/16

(52) U.S. Cl. 439/578; 29/874; 285/405

(57) ABSTRACT

A coaxial cable connector configured to couple a coaxial cable having a conductive shield around a dielectric insulator and a mating connector is provided. The coaxial cable connector includes a fastener configured to engage the mating connector, a body coupled to the fastener, and a post received within the fastener, the post comprising a non-conductive plastic member having a conductive plating applied to the exterior thereof. The conductive plating is configured to provide a conductive path between the conductive shield of the coaxial cable and at least one of the fastener and the mating connector.

### BACKGROUND

The present disclosure relates generally to the field of coaxial cable connectors used to connect coaxial cables to various electronic devices such as televisions, antennas, set-top boxes, and similar devices. More specifically, the present disclosure relates to a coaxial cable connector having one or more components formed of a non-conductive material plated with a conductive material.

Conventional coaxial cable connectors generally include a connector body, a nut coupled to the connector body, and an annular post coupled to the nut and/or the body. A locking sleeve may further be used to secure a coaxial cable within the body of the coaxial cable connector. Typically, the nut and the annular post are constructed of conductive metals or conductive plastics.

There are many challenges associated with providing coaxial cable connectors that are low cost and maintain high quality connections with coaxial cables.

### SUMMARY

One embodiment relates to a coaxial cable connector configured to couple a coaxial cable and a mating connector, the coaxial cable having a conductive shield around a dielectric insulator. The coaxial cable connector includes a fastener configured to engage the mating connector, a body coupled to the fastener, and a post received within the fastener, the post comprising a non-conductive plastic member having a conductive plating applied to the exterior thereof. The conductive plating is configured to provide a conductive path between the conductive shield of the coaxial cable and at least one of the fastener and the mating connector.

Another embodiment relates to a method of manufacturing a coaxial cable connector, the method including providing a connector body having a forward end and a rearward end, providing a nut, and providing an annular post formed of a non-conductive material plated with a conductive material. The method further includes inserting the annular post into the connector body and rotatably coupling the nut to the connector body.

Another embodiment relates to a post configured for use in a coaxial cable connector having a nut and a body. The post includes a flange defining a forward end, a tubular portion extending rearwardly from the flange to a rearward end, and a conductive layer provided on the flange and tubular portion. The flange and tubular portion are formed from a non-conductive material.

### BRIEF DESCRIPTION OF THE DRAWINGS

FIG. 1 is a perspective view of a coaxial cable connector according to an exemplary embodiment.

FIG. 2 is an axial cross-sectional view of the coaxial cable connector taken along line 2-2 of FIG. 1 according to an exemplary embodiment.

FIG. 3 is an exploded perspective view of the coaxial cable connector of FIG. 1 according to an exemplary embodiment.

FIG. 4 is schematic axial cross-sectional view of a portion of the coaxial cable connector taken along line 4-4 of FIG. 1 according to an exemplary embodiment.

FIG. 5 is a flow chart of a process for manufacturing a coaxial cable connector, shown according to an exemplary embodiment.

### DETAILED DESCRIPTION

Referring to the FIGURES generally, coaxial cable connectors typically include a connector body (e.g., an annular collar) for acconunodating a coaxial cable. An annular nut may be rotatably connected to the body for providing mechanical attachment of the connector to an external device (e.g., a mating connector). An annular post may be coupled to the body. The nut may include a threaded portion or other attachment feature (e.g., an RCA port, a BNC port, etc.) that enables attachment of the connector to a mating connector or other device. The body includes a rearward portion configured to receive the coaxial cable. The connector may further include a locking sleeve or other component intended to facilitate retention of the cable within the connector.

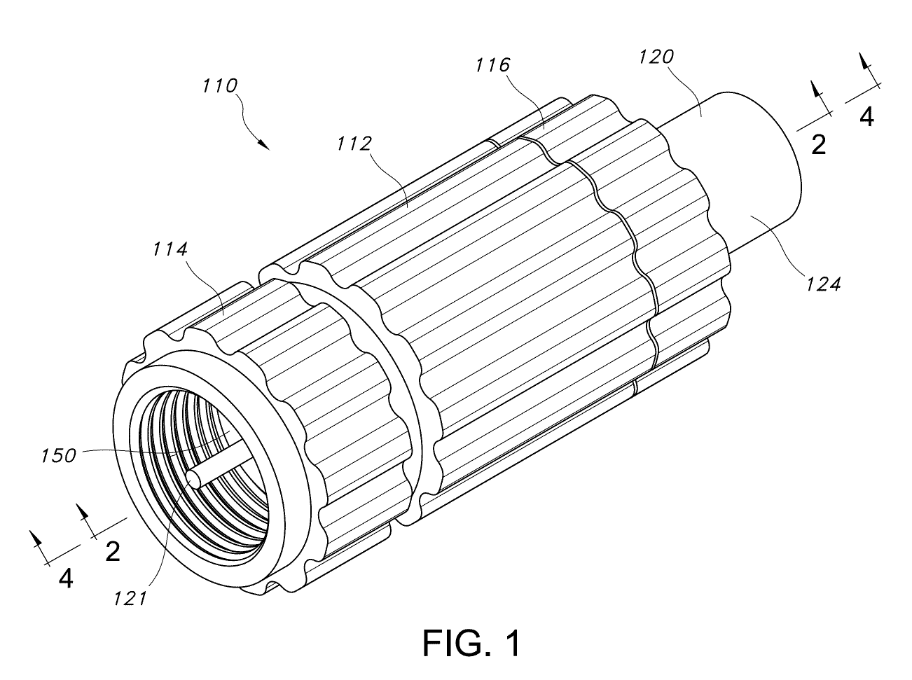

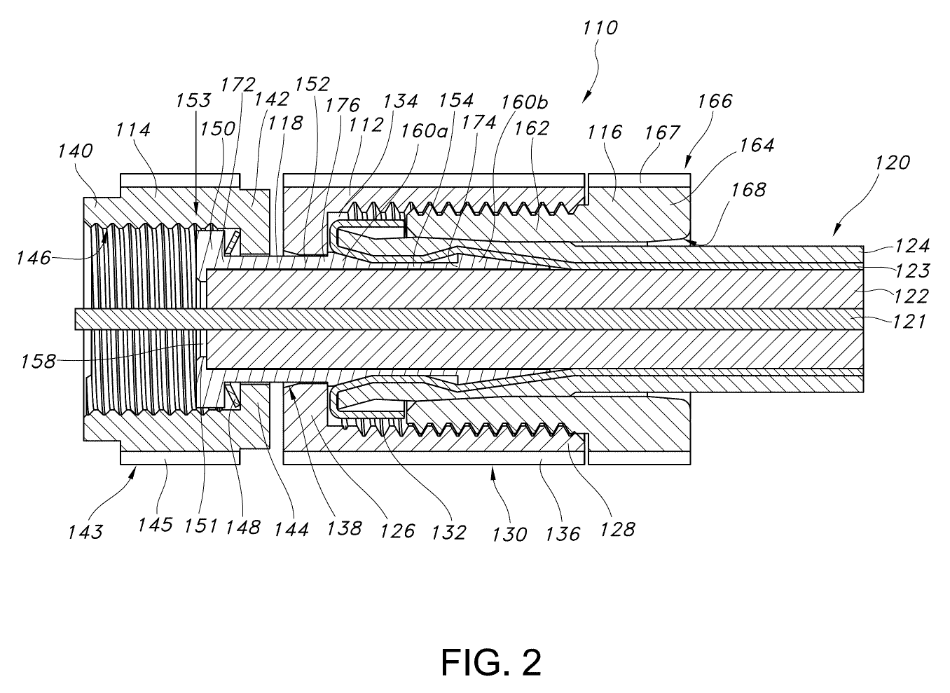

Referring to FIGS. 1 and 2, a coaxial cable includes a center core, shown as inner conductor 121, a dielectric insulator 122 surrounding inner conductor 121, a woven or braided shield surrounding insulator 122, shown as outer conductor 123, and a sheath surrounding outer conductor 123, shown as outer jacket 124. Typically, inner conductor 121 carries a signal, and outer conductor 123 is coupled to ground. Various embodiments disclosed herein relate to an annular post, a fastener, or related components that are usable to electrically couple a coaxial cable to a mating connector. More specifically, an annular post or fastener may be formed of a non-conductive material and plated with a conductive material such that a continuous ground path is created from the outer conductor 123 of the coaxial cable to the mating connector.

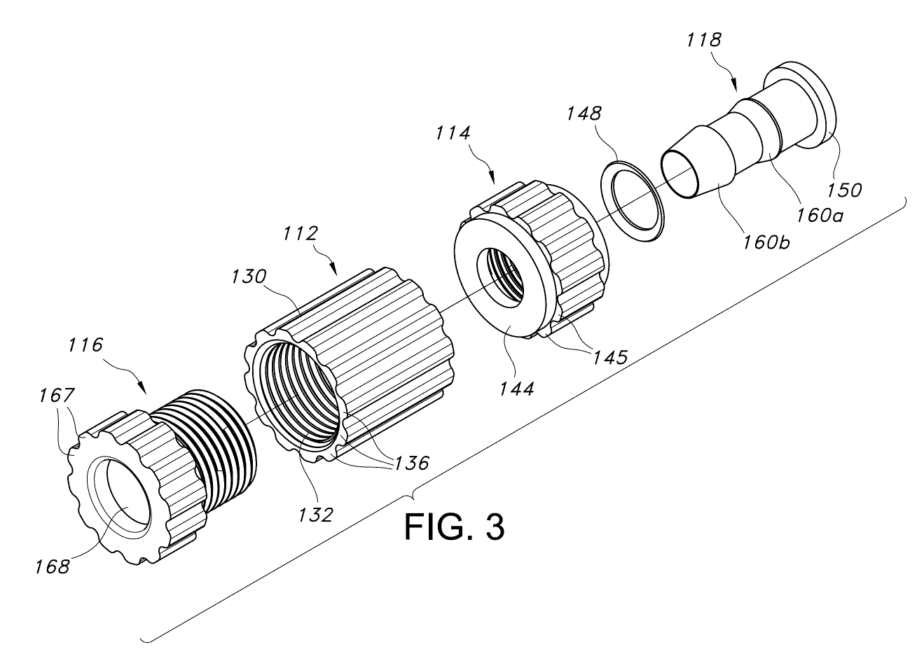

Referring to FIGS. 1-3, a coaxial cable connector 110 is shown according to an exemplary embodiment. Connector 110 is configured to be assembled onto a coaxial cable 120, and includes a connector body 112 (e.g., a collar, body portion, etc.), a fastener or nut 114 (e.g., a threaded nut, a hex nut, RCA interface, BNC interface, etc.) which may or may not be threaded, and a sleeve 116 (e.g., a locking sleeve, compression sleeve, compressible member, etc.). Connector 110 further includes a post 118 provided within one or more of body 112, nut 114, and sleeve 116. Connector 110 may include one or more sealing members (e.g., o-rings, elastomeric o-rings, conductive o-rings, etc.) for preventing moisture or other undesirable materials from entering the interior of connector 110.

According to one embodiment, connector body 112 is a generally cylindrical member having a first, or forward end 126, a second, or rearward end 128, an outer surface 130, an inner surface 132, and an inner bore 134 extending through body 112. Body 112 may be made of a suitable plastic (e.g., polyethylene, polyetherimide, acrylonitrile butadiene styrene (ABS), polycarbonate, etc.), metal (e.g., brass, etc.), or other material and may be cast, molded, cold headed, or made using a different process. Outer surface 130 is shown to include a plurality of axially oriented projections (bumps, ridges, knurling, etc.), shown as ribs 136. Ribs 136 provide a textured region which may improve a user's grasp of body 112, thereby facilitating manipulation and tightening of body 112 to sleeve 116. Alternatively, outer surface 130 may have a smooth, cylindrical surface, or a polygonal surface, which may be configured to receive a tool for tightening connector body 112 to sleeve 116. Inner surface 132 is shown to be a threaded surface configured to receive a mating threaded surface of sleeve 116. Alternatively, inner surface 132 may be substantially smooth or include one or more lips configured to press fit or snap fit with corresponding features of sleeve 116.

As shown in FIG. 2, the inner diameter of body 112 may vary along the length of body 112. For example, forward end 126 of body 112 has a relatively smaller inner diameter to provide a proper fit (e.g., an interference fit, a snap fit, etc.) with post 118. Forward end 126 may include a beveled, rounded, or chamfered edge 138 configured to facilitate insertion of post 118 into body 112 and the passage of barbs 160 through the relatively smaller inner diameter of forward end 126. Between forward end 126 and rearward end 128, body 112 is shown to have a relatively larger inner diameter to accommodate sleeve 116 and cable 120. According to alternate embodiments, body 112 may have a tapered, or otherwise shaped, inner diameter to provide a proper fit for receiving an exterior jacket, shield, or other components of cable 120 between body 112 and post 118.

According to an exemplary embodiment, nut 114 includes a front portion 140, a rear portion 142, an outer surface 143, and an inner surface 146. Front portion 140 may include a threaded internal surface 146 configured to provide a threaded engagement with a mating connector (e.g., a port connector, etc.) or other device (not shown). In alternative embodiments, nut 114 may provide other types of interfaces with mating connectors. Outer surface 143 is shown to include a plurality of axially oriented projections (bumps, ridges, knurling, etc.), shown as ribs 145. Ribs 145 provide a textured region which may improve a user's grasp of nut 114, thereby facilitating manipulation and tightening of nut 114 to the mating connector. Alternatively, outer surface 143 may have a smooth, cylindrical surface, or a polygonal surface (e.g., a hex surface, etc.), which may be configured to receive a tool for tightening nut 114 to the mating connector.

Rear portion 142 of nut 114 may include an inwardly-extending annular flange 144 configured to maintain nut 114 in proper position relative to body 112 and/or post 118 such that nut 114 is rotatably coupled to body 112 and/or post 118. In one embodiment, annular flange 144 acts as a stop to define a rearward limit of axial movement of a biasing or spring mechanism 148. Spring mechanism 148 is shown to be a Belleville washer and is configured to provide electrical continuity between post 118 and the mating connector even if nut 114 loosens from the mating connector, for example, due to thermal expansion. Nut 114 may be made of a plastic (e.g., polyethylene, polyetherimide (e.g., Ultem® 1000 or Ultem® 2300), polyether ether ketone (PEEK), polycarbonate (e.g., Lexan), ABS, etc.), metal (e.g., brass, etc.), or other material and may be cast, molded, cold headed, or made using a different process. According to one embodiment, nut 114 may be formed of a non-conductive substrate plated with a conductive material. According to another embodiment, nut 114 may be constructed of a polyetherimide substrate, a copper flash, and a nickel-tin base plating.

According to an exemplary embodiment, post 118 includes a forward portion 172, a rearward portion 174 located axially opposite forward portion 172, and a middle portion 176 located between forward portion 172 and rearward portion 174. As shown, post 118 includes flanged base portion 150 located in forward portion 172, a radially enlarged portion 152 from which flanged base portion 150 extends, and a generally tubular cylindrical portion 154 extending in a rearward direction from enlarged portion 152 and defining an inner bore 158 therethrough. Post 118 may include an inwardly-extending annular flange 151 configured to act as a stop to limit the forward axial insertion of insulator 122 into post 118. According to the embodiment shown, flanged base portion 150 and inwardly-extending annular flange 151 define a forwardmost end of post 118, shown as reference plane 153, which is configured to abut the rearwardmost end of the mating connector and thereby complete a ground path from the mating connector to outer conductor 123. According to various embodiments, flanged base portion 150 physically and/or electrically couples to the mating connector. One or more annular barbs 160 (e.g., projections, serrations, ramped flange portions, etc.), shown as first barb 160a and second barb 160b, may extend from an outer surface of post 118. First barb 160a is shown to be located on middle portion 176 of post 118 and to be configured to longitudinally limit the movement of post 118 relative to body 112. For example, barb 160a is shown to have a greater diameter than the relatively smaller inner diameter of forward end 126 of body 112. Accordingly, when barb 160a is pushed through body 112, barb 160a forms a snap-fit between post 118 and body 112, thereby retaining post 118 even though post 118 and body 112 may have different rates of thermal expansion. Second barb 160b is shown located on rearward portion 174 of post 118 and configured to improve retention of cable 120 within connector 110. Post 118 is configured to receive an inner conductor 121 and insulator 122 of cable 120 within inner bore 158, such that the outer conductor 123 and/or jacket 124 of cable 120 are positioned between post 118 and body 112 and/or sleeve 116.

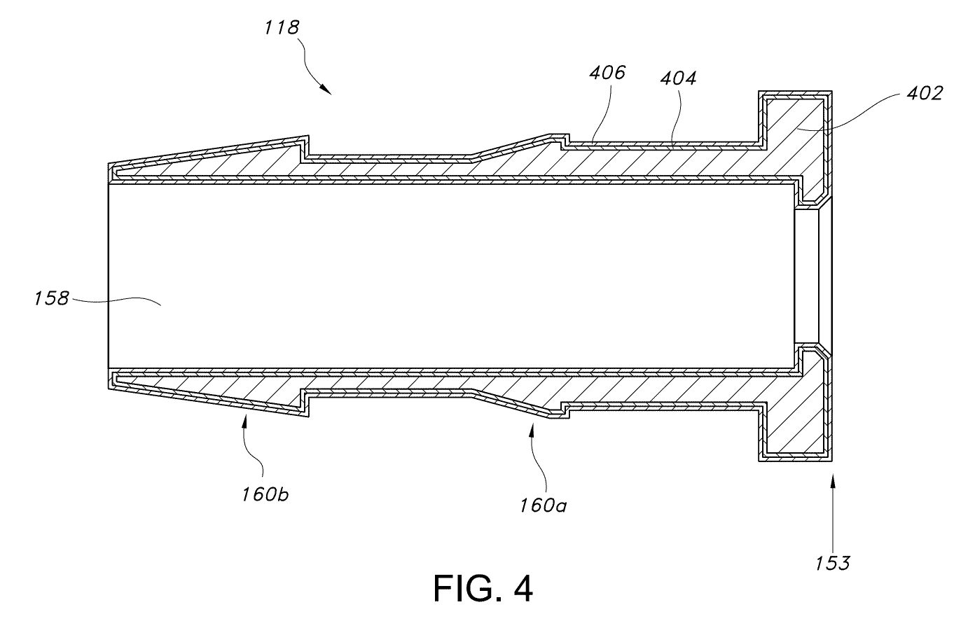

According to one embodiment, post 118 is formed of plastic, metal, other suitable material, or combinations thereof. According to another embodiment, post 118 is formed of a non-conductive material, such as plastic (e.g., polyethylene, polyetherimide, PEEK, polycarbonate (e.g., Lexan), etc.), and plated with a conductive material, such as metal. According to an exemplary embodiment shown in FIG. 4, post 118 is constructed of a polyetherimide (e.g., Ultem® 1000 or Ultem® 2300) substrate 402 plated with a nickel-tin base alloy, shown as plating 406. Polyetherimide may provide advantageous characteristics such as low thermal expansion and low water absorption. According to one embodiment, a flash 404 (e.g., copper) is applied to substrate 402 prior to applying plating 406 in order to improve the adherence of plating 406 to post 118. A flash or strike is a very thin, high quality plating deposit which has good adherence to a substrate and serves as a foundation for a subsequent plating process. It should be noted that the thicknesses of flash 404 and plating 406 are shown schematically and not to scale. For example, a flash is typically less than 0.1 microns thick. However, flashing a plastic substrate 402 typically requires a flash 404 greater than 0.1 microns thick. According to one embodiment, flash 404 is less than about 1 micron thick. According to another embodiment, flash 404 is less than about 3 microns thick. According to an exemplary embodiment, flash 404 is substantially thinner than plating 406. According to one embodiment, plating 406 has a thickness of at least 100 microns. According to the exemplary embodiment, plating 406 has a thickness of between about 400 microns and about 500 microns. Providing a plating thickness of between about 400 microns and about 500 microns provides sufficient thickness for current and electrical signal to pass through plating 406 without losing signal (i.e., prevent signal degradation due to insufficient skin depth), without creating excess temperature in the cable and/or connector, and without providing excess plating thickness and unnecessary cost. In contrast, a conductive substrate, such as metal, typically only requires plating of 0.1 to 0.4 microns thick because some of the current passes through the substrate.

According to one embodiment, conductive plating 406 provides a conductive path between outer conductor 123 of cable 120 to at least one of nut 114 and a mating connector. According to the embodiment shown, plating 406 forms a conductive path from barb 160b to reference plane 153 (e.g., defined by the forward most surface of post 118). According to another embodiment, nut 114 is conductive such that electrical continuity may be created from the mating connector through nut 114 and through post 118 to outer conductor 123. According to an exemplary embodiment, nut 114 and post 118 are constructed of polyetherimide substrates, copper flash, and nickel-tin alloy plating. According to another embodiment, body 112, nut 114, and sleeve 116 are formed of a non-plated plastic, and post 118 is formed of a conductively plated plastic. Using plastic for components reduces manufacturing costs versus using metal.

According to an exemplary embodiment, sleeve 116 includes a front portion 162, a rear portion 164, an outer surface 166, and an inner surface 168. Sleeve 116 may be made from a metal (e.g., brass), plastic (e.g., polyethylene, PEEK, ABS, polycarbonate, etc.), or another suitable material, and may be machined, injection molded, or made using a different process. Sleeve 116 is configured to be moveable from a first position (e.g., a pre-assembly, or unassembled, position), where sleeve 116 may be separated, or detached, from body 112 to facilitate assembly of connector 110, to a second position, as shown in FIG. 2 (e.g., a post-assembly, or assembled, position), where sleeve 116 may be retained within body 112 in a more secure, or permanent, fashion. At least a portion of outer surface 166 of sleeve 116 may be configured to threadably engage inner surface 132 of body 112. According to alternate embodiments, sleeve 116 and body 112 may be provided with corresponding interfacing features (e.g., indents/detents, projections/recesses, etc.) configured to maintain sleeve 116 in the first and/or second positions. Inner surface 168 may be configured to gradually compress outer conductor 123 and/or jacket 124 between sleeve 116 and barb 160b of post 118 as sleeve 116 is inserted into body 112. As shown, inner surface 168 includes an internally convex, tapered, or curvilinear surface. Outer surface 166 is shown to include a plurality of axially oriented projections (bumps, ridges, knurling, etc.), shown as ribs 167. Ribs 167 provide a textured region which may improve a user's grasp of sleeve 116, thereby facilitating manipulation and tightening of sleeve 116 to body 112. Alternatively, outer surface 166 may have a smooth, cylindrical surface, or a polygonal surface, which may be configured to receive a tool for tightening sleeve 116 to body 112. Sleeve 116 and body 112 may be configured so that sleeve 116 moves within body 112 to provide compression to the cable jacket or so that sleeve 116 moves on the outside of body 112 and presses body 112 inward to provide compression to the cable jacket.

According to an exemplary embodiment, connector 110 is assembled by inserting the rearward and middle portions 174, 176 of post 118 through spring mechanism 148 and through annular flange 144 of nut 114. Post 118 is inserted through forward end 126 of body 112 until spring mechanism 148, annular flange 144 of nut 114, and forward end 126 of body 112 are retained between flanged base portion 150 and barb 160a of post 118. In use, coaxial cable 120 is passed through sleeve 116 while sleeve 116 is in a first, unassembled, position. Cable 120 is then inserted into bore 134 of body 112. As coaxial cable 120 encounters barb 160b outer conductor 123 separates from insulator 122 such that outer conductor 123 and jacket 124 pass outside of post 118, and insulator 122 and inner conductor 121 pass through inner bore 158 of post 118 until insulator 122 reaches annular flange 151 of post 118. Sleeve 116 is moved forward along coaxial cable 120 until sleeve 116 engages body 112. According to an exemplary embodiment, sleeve 116 is rotated, screwed, or driven into body 112 until sleeve 116 reaches a second, assembled, position. As sleeve 116 is moved relative to body 112, inner surface 168 of sleeve 116 compresses jacket 124 and outer conductor 123 onto barb 160b of post 118, thereby securing connector 110 onto coaxial cable 120. Compressing outer conductor 123 against post 118 ensures electrical contact between outer conductor 123 and plating 406, thereby creating an electrical path between flanged base portion 150 and outer conductor 123 via plating 406. In use, connector 110 may then be moved (e.g., driven, pushed, screwed, coupled, etc.) on to the mating connector such that flanged base portion 150 is physically and/or electrically coupled to the mating connector.

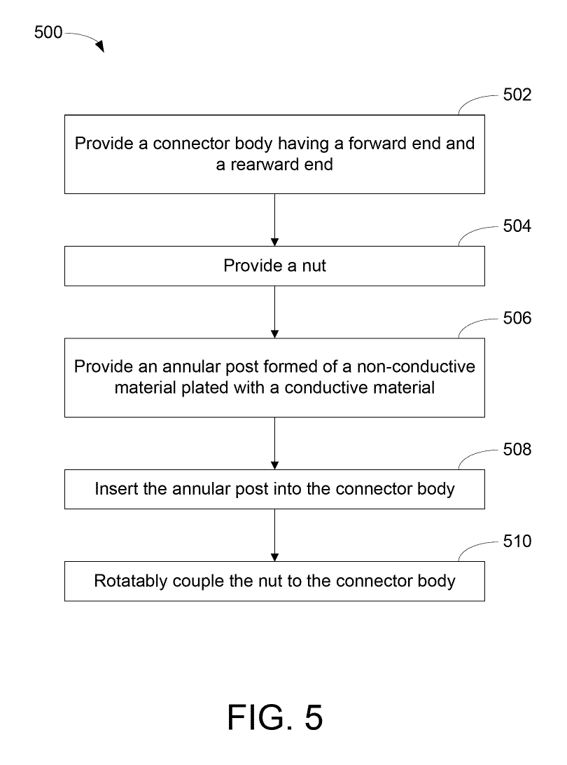

Referring to FIG. 5, a flowchart of a process 500 for manufacturing a coaxial cable connector is shown according to an exemplary embodiment. Process 500 is shown to include the steps of providing a connector body having a forward end and a rearward end (step 502), providing a nut (step 504), and providing an annular post formed of a non-conductive material plated with a conductive material (step 506). Process 500 is further shown to includes the steps of inserting the annular post into the connector body (step 508) and rotatably coupling the nut to the connector body (step 510).

Various alternate embodiments of the process described are contemplated. For example, the order of steps may be changed, e.g., providing a connector body (step 502), providing a nut (step 504), and providing an annular post (step 506) may be performed in any order or substantially simultaneously. Process 500 may include additional steps. For example, process 500 may include the steps of providing a post substrate formed of a non-conductive material, depositing a flash on the post substrate, and plating the post substrate with a conductive material to form the annular post. Process 500 may further include the steps of providing a nut substrate formed of a non-conductive material, and plating the nut substrate with a conductive material to form the nut.

The plating processes described herein may include electroplating, electrode deposition, electroless deposition, or any other suitable form of plating. The plated components may be completely plated or partially plated (e.g., plating the outer surface only, plating one side of the component, plating stripes on the component, etc.). According to one embodiment, at least a portion of the plated components are plated. According to another embodiment, more than 25% of the surface of the non-conductive substrate of a plated component is plated. According to another embodiment, more than 50% of the non-conductive substrate is plated. According to another embodiment, more than 75% of the non-conductive substrate is plated. According to another embodiment, an axial portion of the non-conductive substrate 402 is plated. According to another embodiment, the plated portion of non-conductive substrate 402 extends from rearward end 174 to flanged base portion 150. According to another embodiment, at least a portion of inner surface 146 of nut 114 is plated.

It should be noted that for purposes of this disclosure, the term coupled means the joining of two members directly or indirectly to one another. Such joining may be stationary in nature or moveable in nature and/or such joining may allow for the flow of fluids, electricity, electrical signals, or other types of signals or communication between the two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

The construction and arrangement of the elements of the connector as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the enclosure may be constructed from any of a wide variety of materials that provide sufficient strength or durability, in any of a wide variety of colors, textures, and combinations. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner. Accordingly, all such modifications are intended to be included within the scope of the present inventions. Other substitutions, modifications, changes, and omissions may be made in the design, operating conditions, and arrangement of the preferred and other exemplary embodiments without departing from the spirit of the appended claims.

The order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes and omissions may be made in the design, operating configuration, and arrangement of the preferred and other exemplary embodiments without departing from the spirit of the appended claims.

What is claimed is:

1. A coaxial cable connector configured to couple a coaxial cable and a mating connector, the coaxial cable having a conductive shield around a dielectric insulator, the coaxial cable connector comprising:
a fastener configured to engage the mating connector;
a body coupled to the fastener; and
a post received within the fastener, the post comprising a non-conductive plastic member having a conductive plating disposed on at least a portion of the exterior thereof;
wherein the conductive plating is configured to provide a conductive path between the conductive shield of the coaxial cable and at least one of the fastener and the mating connector.

2. The coaxial cable connector of claim 1, wherein the fastener is formed of a non-conductive plastic having a conductive plating disposed on at least a portion of the exterior thereof.

3. The coaxial cable connector of claim 1, wherein the non-conductive plastic is a polyetherimide.

4. The coaxial cable connector of claim 1, wherein the conductive plating is an alloy comprising nickel and tin.

5. The coaxial cable connector of claim 1, wherein the plating comprises a thickness of at least 100 microns.

6. The coaxial cable connector of claim 1, wherein the plating comprises a thickness of between about 400 microns and about 500 microns.

7. The coaxial cable connector of claim 1, wherein the post comprises:
a forward portion;
a rearward portion located longitudinally opposite the forward portion;
a middle portion located between the forward portion and the rearward portion;
a flange located in the forward portion and configured to electrically couple to the mating connector;
a first barb located in the middle portion and configured to longitudinally limit the movement of the post relative to the body; and
a second barb located in the rearward portion and configured for insertion between the conductive shield and the dielectric insulator.

8. A method of manufacturing a coaxial cable connector, the method comprising:
providing a connector body having a forward end and a rearward end;
providing a nut;
providing an annular post formed of a non-conductive material plated with a conductive material;
inserting the annular post into the connector body; and
rotatably coupling the nut to the connector body.

9. The method of claim 8 further comprising:
providing a post substrate formed of a non-conductive material; and
plating at least a portion of the post substrate with a conductive material to form the annular post.

10. The method of claim 9 further comprising:
depositing a flash on the post substrate prior to plating the post substrate with the conductive material.

11. The method of claim 10, wherein the flash comprises copper.

12. The method of claim 8, wherein the non-conductive material is a polyetherimide.

13. The method of claim 8, wherein the conductive material is an alloy comprising nickel and tin.

14. The method of claim 8 further comprising:
providing a nut substrate formed of a non-conductive material; and
plating the nut substrate with a conductive material to form the nut.

15. A post configured for use in a coaxial cable connector having a nut and a body, the post comprising:
a flange formed from a non-conductive material and defining a forward end;
a tubular portion formed from a non-conductive material and extending rearwardly from the flange to a rearward end; and
a conductive layer provided on at least a portion of each of the flange and tubular portion.

16. The post of claim 15, wherein the flange comprises a forward surface configured to contact a mating connector.

17. The post of claim 16, wherein the conductive layer is configured to form at least part of a conductive path between a conductive shield of a coaxial cable and the mating connector.

18. The post of claim 15, wherein the plating has a thickness of between about 400 microns and about 500 microns.

19. The post of claim 15, wherein the plating has a thickness of at least 100 microns.

20. The post of claim 15, wherein the tubular portion comprises a barb located between the flange and the rearward end and is configured to snap fit the post to the connector body.
